(19) United States
(12) Patent Application Publication
(10) Pub. No.: US 2010/0245385 A1
(43) Pub. Date: Sep. 30, 2010

(54) PAGE REGION IMAGE OFFSET METHODS AND SYSTEMS

(75) Inventors: Javier A. Morales, Rochester, NY (US); Michael E. Farrell, Ontario, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 12/411,888

(22) Filed: Mar. 26, 2009

(51) Int. Cl. G09G 5/00

(52) U.S. Cl. 345/619

(57) ABSTRACT

A method and system for rendering a raster image. A raster image can be analyzed with respect to the specialty media upon which the raster image is rendered, in order to determine if a difference exists between particular sections of the specialty media and the raster image. Thereafter, one or more regions of the raster image can be selected for offsetting, if it is determined that such a difference does exist, in order to thereafter re-render the raster image and thereby provide a non-destructive editing capability with respect to the raster image and a rapid resolution of quality problems associated with rendering the raster image via the specialty media.

### TECHNICAL FIELD

Embodiments are generally related to rendering devices and customized media. Embodiments also relate in general to the field of computers and similar technologies and in particular to software utilized in this field. In addition, embodiments relate to methods and systems for the rendering of specialty media. Embodiments also relate to raster image processing.

### BACKGROUND OF THE INVENTION

A raster image processor (RIP) provides output data in a format that is suitable for rendering by an output device. One suitable format is binary dot patterns forming a bitmap. Rendering by the output device may include, for example, printing via a printer or display of information on a screen or monitor. The raster image processor receives input of one or more page descriptions. The page descriptions include information about fonts, graphics, and the like that describe the appearance of each page. The page descriptions may be in a high level language or even another bitmap of higher or lower resolution than the output device. Some examples of high level page description languages are PostScript (PS), Portable Document Format (PDF) and Extensible Markup Language (XML) Paper Specification (XPS). The raster image processor may be implemented either as software, firmware, or hardware. Typically, the raster image processor resides in a digital front end (DFE). The raster image processor performs raster image processing (RIPping). Raster image processing is the process of translating the page descriptions into a bitmap for output by the output device (e.g., desktop printer).

Raster image processing for some files may take an unreasonably long time to process. Often, this is true for large files containing color graphics and/or variable data. Files containing color graphics by their nature tend to have large page descriptions and correspondingly large bitmaps. Variable data files allow documents to be customized or personalized. With the increase in demand for color and personalized communications, there has been a noticeable decrease in performance of raster image processors.

Rendering images on specialty media for customized photo applications, for example, can present a particular challenge because of the stringent requirements of the media utilized and also when utilized in the context of raster imaging processing. The majority of retail photo operations, for example, which provide differentiated photo products through specialty photo media such as, for example, FlipPix, may possess unique problems due to the combination of expensive media and high turnover in a retail environment. Note that “FlipPix” is a trademark of IMCOM, Inc. of Salt Point, N.Y.

Media for photo applications, for example, such as that used for FlipPix, is precut with fairly complicated dies that require very tight registration within all areas of the page. The photo content must not only fall in the correct place on the page, but specific images and specific places where images abut must be lined up to specific cut lines or fold lines within the media. This can present a problem when rendering on digital presses, particularly because current approaches only allow an entire page to be shifted, but not a region in the page, which makes it difficult to offset images for enhanced rendering.

Based on the foregoing, it is believed that a need exists for an improved method and system that permits particular regions of a page to be selected and shifted in order to permit specifying an image offset. Such an approach and more are disclosed in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for an improved method and system for rendering customized media via rendering devices, such as printers, scanners, multi-function devices, photocopy machines, and the like.

It is yet a further aspect of the present invention to provide for improved methods and systems for the rendering of specialty media.

The aforementioned aspects and other objectives and advantages can now be achieved as described herein. Methods and systems for rendering a raster image are disclosed. A raster image can be analyzed with respect to the specialty media upon which the raster image is rendered, in order to determine if a difference exists between particular sections of the specialty media and the raster image. Thereafter, one or more regions of the raster image can be selected for offsetting, if it is determined that such a difference does exist, in order to thereafter re-render the raster image and thereby provide a non-destructive editing capability with respect to the raster image and a rapid resolution of quality problems associated with rendering the raster image via the specialty media. The identified difference between the particular sections of the specialty media and the raster image may be, for example, a misalignment between such sections of the specialty media and the raster image. The raster image can be then re-rendered after selecting the region(s) of the raster image to offset, wherein the raster image when re-rendered includes the offset. Note that the misalignment can be detected on a printed sheet of paper.

As utilized herein, the term “raster image” can refer to, for example, a ripped image. The term “RIP” or “rip” refers generally to “Raster Image Processor,” which is typically the hardware and/or software which converts data which has been stored in a memory location of a data-processing system/apparatus, such as a computer, into a series of lines of tiny dots which are output on film or photographic paper. In line work, the dots can be grouped to create solid areas.

The approach described herein thus provides for an enhancement to the existing image offset functionality to enable offset of specific portions of the raster image (e.g., RIPped image content). A user can enter an “enhanced” offset mode in which the user can then specify regions of the raster image (e.g., RiPped document) to offset. The user can define offset regions automatically (since photo applications using specialty media place discrete content items on the page) or manually, depending upon design considerations.

Such an approach permits the performance of image shifts (and other operations) on page regions as part of the RiPping and rendering process, along with the ability to create multiple permanent, editable image selections. The disclosed approach also provides for non-destructive editing (note that prior art approaches only offer non-destructive editing that is limited to filters that are applied to the entire image, e.g., adjustment layers). The disclosed approach also provides for the automatic creation of page region areas for sub-page image shift and other operations, along with enabling a media definition capable of comprehending die cuts in addition to other typical media properties. The definitions of image shift (and other operation) areas, for example, can be based on the die cut description. By following such an approach, page region image shifts (and other manipulations) provide a mechanism to resolve typical quality problems associated with printing on specialty media such as, for example, FlipPix media.

The proposed methodology permits a user to specify an image (x, y) offset at the DFE (Digital Front End) for selected regions on a page. Currently an entire page can be shifted, but not a region in the page. A user can then enter an “enhanced” offset mode in which he or she would be able to specify regions of the RiPped document to offset. The regions can be either manually selected by the user or automatically highlighted by the system. Such an approach is particularly useful in printing personalized packaging (e.g., where images are placed on top and sides of a box and need to be adjusted at the printer), or when printing on specialty media that requires precise intra-page registration.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a flow chart of operations illustrating logical operational steps of a method for rendering a raster image with a page region image offset, in accordance with a preferred embodiment;

FIG. 4 illustrates a flow chart of operations illustrating logical operational steps of a method for enabling a mechanism for defining page definitions available for image offset, in accordance with a preferred embodiment;

FIG. 5 illustrates a flow chart of operations illustrating logical operational steps of a method for enabling a mechanism for defining page definitions available for image offset, in accordance with an alternative embodiment; and

FIG. 6 illustrates a flow chart of operations illustrating logical operational steps of a method for defining page regions based on enhanced media definitions, in accordance with an alternative embodiment.

### DETAILED DESCRIPTION

The particular values and configurations discussed in these non-limiting examples can be varied and are cited merely to illustrate at least one embodiment and are not intended to limit the scope of such embodiments.

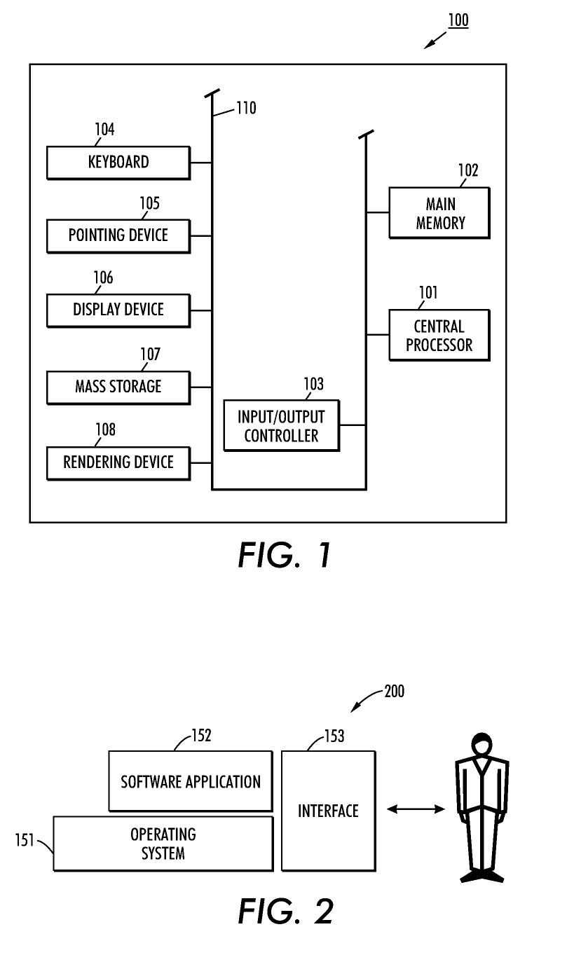

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied and/or implemented in the context of a data-processing system 100 that generally includes a central processor 101, a main memory 102, an input/output controller 103, an input device 104 such as, for example, a keyboard 104, a pointing device 105 (e.g., mouse, track ball, pen device, or the like), a display device 106, and mass storage 107 (e.g., hard disk). Additional input/output devices, such as a rendering device 108, may be utilized in association with the data-processing system 100 as desired. As illustrated, the various components of the data-processing system 100 communicate through a system bus 110 or similar architecture.

Illustrated in FIG. 2, a computer software system 200 can be provided for directing the operation of the data-processing system 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing system 100. The data-processing system 100 receives user commands and data through user interface 153; these inputs may then be acted upon by the data-processing system 100 in accordance with instructions from operating module 151 and/or application module 152.

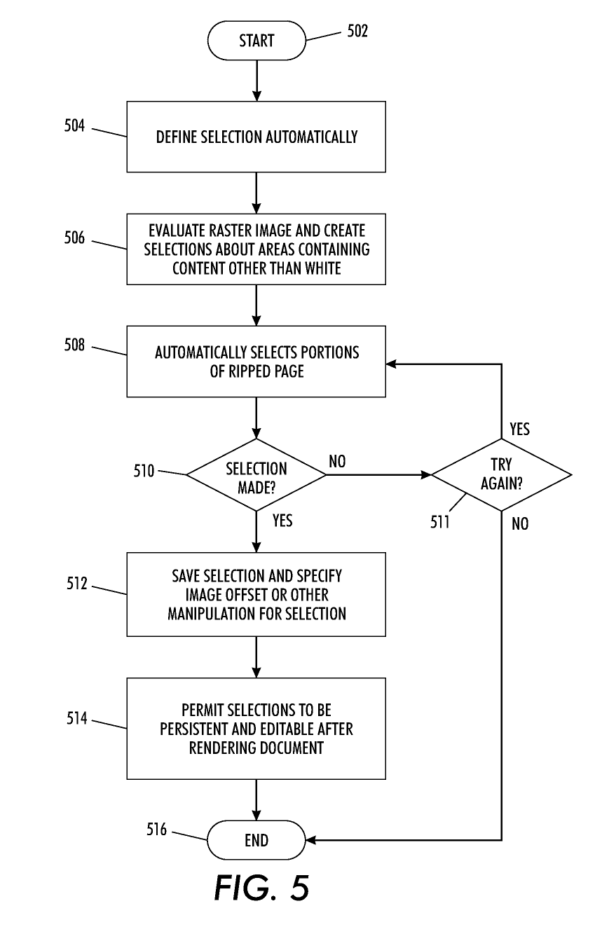

The interface 153, which is preferably a graphical user interface (GUI), also serves to display results, whereupon the user may supply additional inputs or terminate the session. In one particular embodiment, operating system 151 and interface 153 can be implemented in the context of a “Windows” system. In another embodiment, operating system 151 and interface 153 may be implemented in the context of other operating systems, such as Linux, UNIX, etc. Application module 152, on the other hand, can include instructions such as the various operations described herein with respect to the various components and modules described herein such as, for example, the method 500 depicted in FIG. 5.

The following description is presented with respect to embodiments of the present invention, which can be embodied in the context of a data-processing system such as data-processing system 100 and computer software system 150 depicted respectively in FIGS. 1-2. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

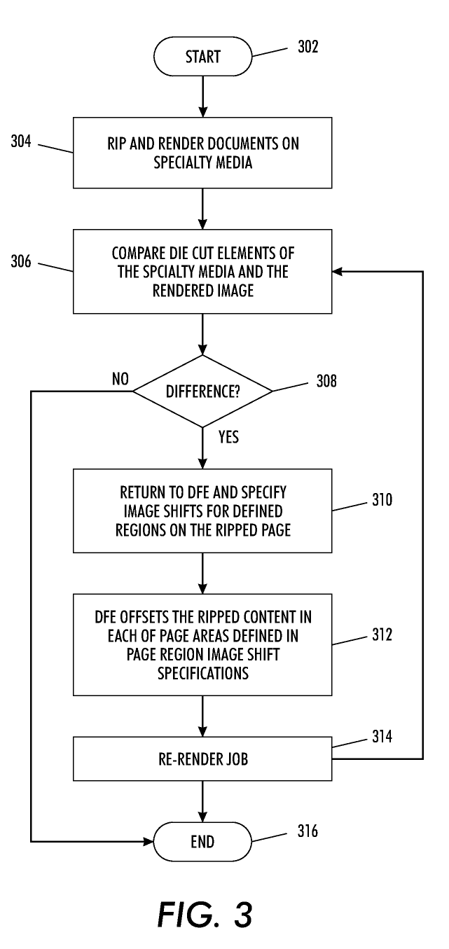

FIG. 3 illustrates a flow chart of operations illustrating logical operational steps of a method 300 for rendering a raster image with a page region image offset, in accordance with a preferred embodiment. Note that the methods 300, 400, 500 and 600 respectively depicted in FIGS. 3-6 can be implemented in the context of a computer-useable medium that contains a program product. Such methods may also be implemented in a computer-usable medium containing a program product.

Programs defining particular functions/instructions such as those depicted in FIGS. 3-6 can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having components in the form of hardware, software, or a combination of software and hardware as described herein or their equivalent.

Thus, the methods 300, 400, 500 and 600 respectively illustrated in FIGS. 3, 4, 5, and 6 and described herein can be deployed as process software in the context of a computer system or data-processing system such as that depicted, for example, in FIGS. 1-2. The instructions of methods 300, 400, 500, 600 can, for example, be stored in, for example, the main memory 102 and/or mass storage 107 of FIG. 1 and then processed via the processor 101. Rendering operations and “RIPping” for example, may take place via the rendering device 108.

Note that as utilized herein, a raster image processor (RIP) can provide output data in a format that is suitable for rendering by an output device. Processor 101 may be configured, for example, in the context of a RIP. One suitable format is raw, binary dot patterns forming a bitmap. Rendering by the output device may include rendering such as, for example, printing by a printer, displaying on a screen, and scanning by a scanner. A raster image processor receives input of one or more page descriptions. The page descriptions include information about fonts, graphics, and the like that describe the appearance of each page.

The page descriptions may be implemented in a high level language or even another bitmap of higher or lower resolution than the output device, depending on design considerations. Some examples of high level page description languages are PostScript (PS), Portable Document Format (PDF) and Extensible Markup Language (XML) Paper Specification (XPS). The raster image processor may be implemented either as software, firmware, or hardware. Typically, the raster image processor resides in a digital front end (DFE). The raster image processor performs raster image processing (RIPping). Raster image processing is the process of translating the page descriptions into a bitmap for output by the output device (e.g., desktop printer, photo printer, digital press, etc).

As indicated at block 302 in FIG. 3, the process can be initiated. Next, as depicted at block 304, an image can be ripped and rendered. For example, a user may RIP and print documents on specialty photo media. Thereafter, as illustrated at block 306, an operation can be performed to compare die cut elements of the specialty media and the rendered image. Next, as described at block 308, a test can be performed to determine if a difference exists between the raster image (e.g., the RIPped page) and the specialty media upon which the raster image is rendered. In the scenario illustrated at block 308, for example, if it is determined that there are no differences between the specialty media and the raster image, the process can simply end, as illustrated at block 316.

If, however, it is determined that a difference does exist, such as a misalignment exists between the die cut elements of the specialty media and the printed image, a user can return to the DFE and specify image shifts for defined regions on the RiPped page, as indicated thereafter at block 310. Before rendering the job, the DFE can then offset the RiPped content in each of the page areas defined in the page region image shift specifications, as illustrated at block 312. The job can then be re-rendered, as indicated at block 314. Following processing of the operation described at block 314, the operation depicted at block 306 can then be processed, followed by processing the operations illustrated at blocks 306, 308, 310, 312, 314, etc., until finally, the entire process ends, as depicted at block 316. Note that the misalignment is capable of being detected on a printed sheet of paper.

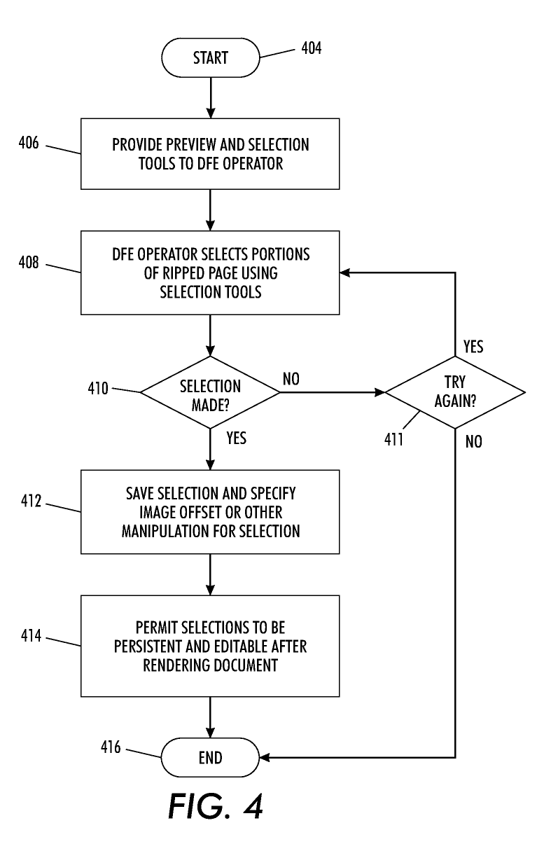

FIG. 4 illustrates a flow chart of operations illustrating logical operational steps of a method 400 for enabling a mechanism for defining page definitions available for image offset, in accordance with a preferred embodiment. Note that the method 400 can be implemented as a standalone methodology or in association with the method 300 depicted in FIG. 3. As depicted at block 404 in FIG. 4, the process can be initiated. In a simple implementation, for example, a preview can be provided along with selection tools to a DFE operator, as indicated at block 406. Next, the DFE operator can select portions of the RiPped image using selection tools typically available in image manipulation programs (e.g. marquee, lasso, etc.) as indicated at block 408.

A test can then be performed, as illustrated at block 410, to determine if a selection has been made. If a selection has not been made, then as indicated at block 41 1, a test can be performed to determine if another attempt at a selection is to be made. If so, the operation illustrated at block 408 is repeated and so forth. If not, then the process terminates, as indicated at block 416. If, however, a selection is made with respect to the test depicted at block 410, then once the selection is made, the selection can be saved and the image offset or other manipulation can be specified for the selection as illustrated at block 412. All selections made can be persistent and editable even after rendering the document, as described at block 414. The process can then end, as indicated at block 416.

FIG. 5 illustrates a flow chart of operations illustrating logical operational steps of a method 500 for enabling a mechanism for defining page definitions available for image offset, in accordance with an alternative embodiment. Note that the approach of method 500 can be implemented together with methods 300 and 400 described above, or as a standalone methodology, or in lieu of for example, method 400. The process generally begins, as described at block 502. Thereafter, as depicted at block 504, an operation can be processed for defining the selection automatically. That is, for example, a user can request that selections be defined automatically. In order for this request to be completed, the raster image(s) is evaluated and selections created around areas that have content other than white, as indicated at block 506. Next, as indicated at block 508, portions of the RiPped page can be automatically selected.

Note that because specialty media (e.g., specialty photo product media) is designed to produce a relatively small finished product from a sheet that has been peeled, folded and stuck to itself, the input document contains separate images placed against a white background. Detecting these images in the page is a relatively simple process. Furthermore, a 1-1 relationship to the die cuts in the specialty media exists, so specifying page region selections can produce the desired results.

Following processing of the operation illustrated at block 508, a test can then be performed, as illustrated at block 510, to determine if a selection has been made. If a selection has not been made, then as indicated at block 511, a test can be performed to determine if another attempt at a selection is to be made. If so, then operation illustrated at block 508 is repeated and so forth. If not, then the process terminates, as indicated at block 516. If, however, a selection is made with respect to the test depicted at block 510, then once the selection is made, the selection can be saved and the image offset or other manipulation can be specified for the selection as illustrated at block 512. All selections made can be persistent and editable even after rendering the document, as described at bock 514. The process can then end, as indicated at block 516.

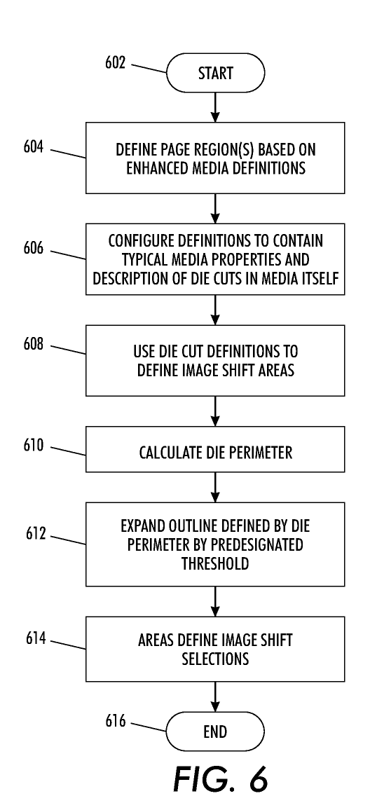

FIG. 6 illustrates a flow chart of operations illustrating logical operational steps of a method 600 for defining page regions based on enhanced media definitions, in accordance with an alternative embodiment. Note that the method 600 depicted in FIG. 6 can be implemented as a standalone method or in association with the methods 300, 400, and 500 described above, depending upon design considerations. As indicated at block 602, the process begins.

Thereafter, as illustrated at block 604, the page region definitions can be based on enhanced media definitions. Such media definitions can contain the typical media properties and/or a description of the die cuts in the media itself, as indicated at block 606. The die cut definitions can then be employed to define image shift areas, as indicated next at block 608. In order to accomplish this, the die perimeter can be calculated, as illustrated at block 610. Thereafter, as described at block 612, an operation can be processed to expand the outline defined by the die perimeter by a user-settable threshold. Such areas would then define the image shift selections as depicted at block 614. The process then terminates, as indicated at block 616.

Note that alternatively, the media definitions can include page regions for offsets instead of a die cut definitions. In this case, the DFE would use the defined areas as they are. In all cases, however, the user would end up with one or more selections of content within the RIPped page. The operations associated with each of these selections are editable either before or after printing the document.

The operations are non-destructive. That is, the system retains the original image data for the document and stores the selection areas and the defined operations for those selection areas. During RiPping, the defined areas as selected and the defined operations are applied to the areas of the document. The resulting image data, however, can be stored as a separate component of the document along with the original input data, region selection definitions, and defined manipulations. The user is thus able to edit the original image's selection areas and manipulations at any time (e.g. after rendering).

Based on the foregoing, it can be appreciated that a number of advantages can result from implementation of the disclosed methods and/or systems. For example, image shifts (and other operations) can be performed on page regions as a part of the RiPping and rendering process. Additionally, another advantage involves the ability to create multiple permanent and editable image selections. Such an approach also has the advantage of providing non-destructive editing and the automatic creation of page regions for sub-page image shift and other operations. Additional advantages include media definition that comprehends die cuts in addition to other typical media properties, along with definitions of image shift (and other operation) areas based on the die cut description. The media definition can also include page region definitions. Finally, page region image shifts and other manipulations can provide a mechanism to resolve typical quality problems associated with rendering on specialty media.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the ad which are also intended to be encompassed by the following claims.

What is claimed is:

1. A method for rendering a raster image, said method comprising:
analyzing a raster image with respect to specialty media upon which said raster image is rendered, in order to determine if a difference exists between particular sections of said specialty media and said raster image; and
selecting at least one region of said raster image to offset, if it is determined that said difference exists, in order to thereafter re-render said raster image and thereby provide a non-destructive editing capability with respect to said raster image and a rapid resolution of quality problems associated with rendering said raster image via said specialty media.

2. The method of claim 1 wherein said difference comprises a misalignment between said particular sections of said specialty media and said raster image.

3. The method of claim 1 further comprising re-rendering said raster image after selecting said at least one region of said raster image to offset, wherein said raster image when re-rendered includes said offset.

4. The method of claim 1 wherein selecting at least one region of said raster image to offset, if it is determined that said misalignment exists, further comprises performing an image shift with respect to said raster image.

5. The method of claim 1 wherein selecting at least one region of said raster image to offset, if it is determined that said misalignment exists, further comprises creating a plurality of permanent and editable image selections.

6. The method of claim 1 further comprising creating a page region area with respect to said at least one region of said raster image for sub-page image shift capabilities thereof.

7. The method of claim 1 further comprising defining said specialty media to include a particular die cut description and other media properties.

8. The method of claim 7 further comprising defining at least one image shift area on said raster image based on said particular die cut description.

9. The method of claim 1 further comprising defining said specialty media to include particular page region definitions.

10. The method of claim 2 wherein said misalignment is detectable on a sheet of paper, said specialty media comprising said sheet of paper.

11. A system rendering a raster image, said system comprising:
a processor;
a data bus coupled to said processor; and
a computer-usable medium embodying computer code, said computer-usable medium being coupled to said data bus, said computer program code comprising instructions executable by said processor and configured for:
analyzing a raster image with respect to specialty media upon which said raster image is rendered, in order to determine if a difference exists between particular sections of said specialty media and said raster image; and
selecting at least one region of said raster image to offset, if it is determined that said difference exists, in order to thereafter re-render said raster image and thereby provide a non-destructive editing capability with respect to said raster image and a rapid resolution of quality problems associated with rendering said raster image via said specialty media.

12. The system of claim 11 wherein said difference comprises a misalignment between said particular sections of said specialty media and said raster image.

13. The system of claim 11 wherein said instructions are further configured for re-rendering said raster image after selecting said at least one region of said raster image to offset, wherein said raster image when re-rendered includes said offset.

14. The system of claim 11 wherein said instructions are further configured for performing an image shift with respect to said raster image.

15. The system of claim 12 wherein said instructions are further configured for creating a plurality of permanent and editable image selections.

16. A computer-usable medium for rendering a raster image, said computer-usable medium embodying computer program code, said computer program code comprising computer executable instructions configured for:
analyzing a raster image with respect to specialty media upon which said raster image is rendered, in order to determine if a difference exists between particular sections of said specialty media and said raster image; and
selecting at least one region of said raster image to offset, if it is determined that said difference exists, in order to thereafter re-render said raster image and thereby provide a non-destructive editing capability with respect to said raster image and a rapid resolution of quality problems associated with rendering said raster image via said specialty media.

17. The computer-usable medium of claim 16 wherein said difference comprises a misalignment between said particular sections of said specialty media and said raster image.

18. The computer-usable medium of claim 16 wherein said embodied computer program code further comprises computer executable instructions configured for re-rendering said raster image after selecting said at least one region of said raster image to offset, wherein said raster image when re-rendered includes said offset.

19. The computer-usable medium of claim 16 wherein said embodied computer program code further comprises computer executable instructions configured for performing an image shift with respect to said raster image.

20. The computer-usable medium of claim 16 wherein said embodied computer program code further comprises computer executable instructions configured for creating a plurality of permanent and editable image selections.
